(19) United States
(12) Patent Application Publication
(10) Pub. No.: US 2017/0027314 A1
(43) Pub. Date: Feb. 2, 2017

(54) Grill Caddy

(71) Applicant: Edward Michael Guzman, Long Beach, CA (US)

(72) Inventor: Edward Michael Guzman, Long Beach, CA (US)

(21) Appl. No.: 15/283,434

(22) Filed: Oct. 2, 2016

Related U.S. Application Data
(63) Continuation-in-part of application No. 15/153,677, filed on May 12, 2016, now abandoned.
(60) Provisional application No. 62/161,138, filed on May 13, 2015.

(51) Int. Cl. A47B 33/00; A47B 9/20; A47B 13/16; A47B 31/04; A47B 13/02; A47J 47/00; A47B 31/00; A47B 13/08; A47J 37/07; A47B 37/00

(52) U.S. Cl. CPC A47B 33/00; A47J 37/0786; A47B 9/20; A47B 13/16; A47B 37/00; A47B 13/02; A47J 47/005; A47B 31/00; A47B 13/086; A47B 31/04; A47B 2031/002

(57) ABSTRACT

The present invention relates to the field of culinary arts. Specifically, a food preparation table and adjustable carrier for outdoor grill supplies and utensils.

### CROSS-REFERENCE TO RELATED APPLICATIONS

This application claims the benefit of U.S. nonprovisional application Ser. No. 15/153,677, filed 12 May 2016, which in turn claims the benefit of U.S. provisional application No. 62/161,138, filed 13 May 2015, both of which are incorporated herein by reference.

### FIELD AND BACKGROUND OF THE INVENTION

1. Field of the Invention

The field of the invention relates to the culinary arts, specifically food preparation utensils.

2. Background of the Invention

Outdoor cooking has been a popular entertainment and family diversion in the United States since the mid-1940s. Common events, such as family reunions, birthday parties and “tailgating” in stadium parking lots before sporting events, such as college and professional football games, utilize outdoor cooking. An industry has arisen to provide the outdoor cook with the accessories needed to successfully perform the outdoor cooking operation. While cooking outdoors has its advantages, such as the ability to prepare foods in a tasty manner and fostering a sense of community at outdoor parties, there are disadvantages, including the smoke and odors produced by outdoor cooking methods, such as cooking over hot coals or using a smoker. Cooking outdoors often requires the chef to transit back and forth between the outdoor grill and an indoor kitchen; for an average person, this is a mere inconvenience, for individuals with disabilities, this can be prohibitive; While permanent outdoor food preparation structures may be built, these can be prohibitively expensive for the average consumer. Furthermore, food preparation on commonly available surfaces, such as picnic tables, are unsanitary and carry a risk of transmitting foodborne illnesses.

Therefore there exists a need for an invention which allows for the ease of preparation of food in an outdoor environment.

### SUMMARY OF THE INVENTION

The exemplary embodiment of the present invention addresses a need to aid in the outdoor preparation of food, which allows convenient and sanitary access to individuals to prepare food in an outdoor setting. The invention consists of a table used as a caddy to hold barbecue supplies and utensils. The table was designed to allow the user to utilize the proper equipment/utensils while cooking/barbecuing. The user can chop on the cutting board provided and slide food directly into a mixing bowl for later use. Features included in the table include: a height adjustable leg; a cup/bottle/can holder; a hooks to hold utensils; stowable and removable containers; a bottle opener; a dispenser for paper towels; a D-ring for hanging of garments or kitchen towels; a magnet for knives or metal utensils; and a basket for holding spices and or condiments.

### BRIEF DESCRIPTION OF THE DRAWINGS

These and other objects, features, and aspects of the invention will be better understood and more fully described upon reading the following detailed description in conjunction with the appended drawings wherein:

FIG. 1 is an overhead perspective view of the invention, a utensil for preparing food at an outdoor grill.

FIG. 2 is an underside perspective view of the invention, a utensil for preparing food at an outdoor grill.

### DETAILED DESCRIPTION

Certain embodiments as disclosed herein provide for a food preparation table and adjustable carrier for outdoor grill supplies and utensils. After reading this description it will become apparent to one skilled in the art how to implement the invention in various alternative embodiments and alternative applications. Although various embodiments of the present invention will be described herein, it is understood that these embodiments are presented by way of example only, and not limitation. As such, this detailed description of various alternative embodiments should not be construed to limit the scope or breadth of the present invention.

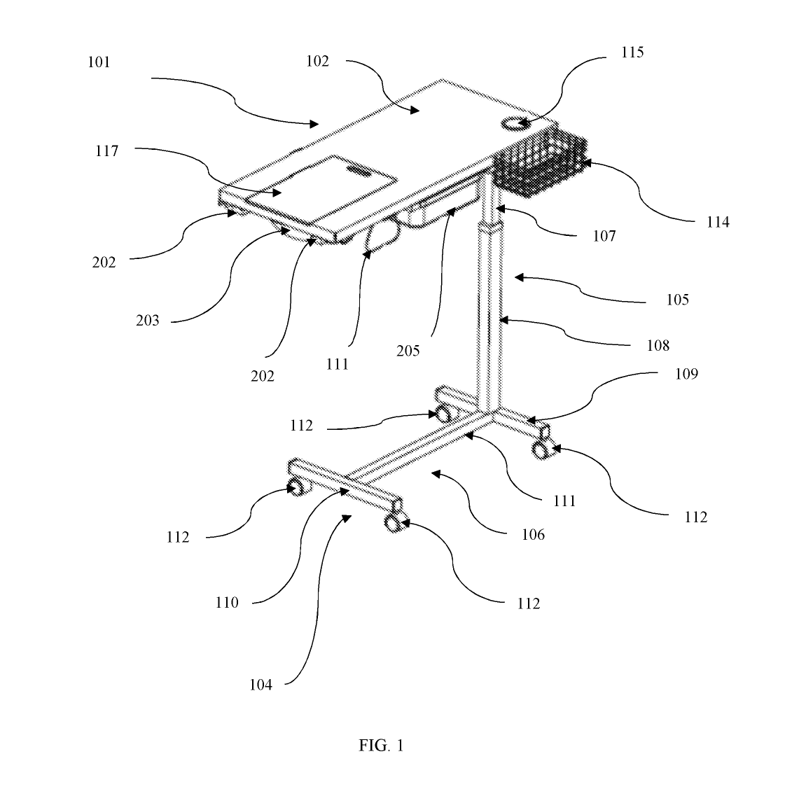

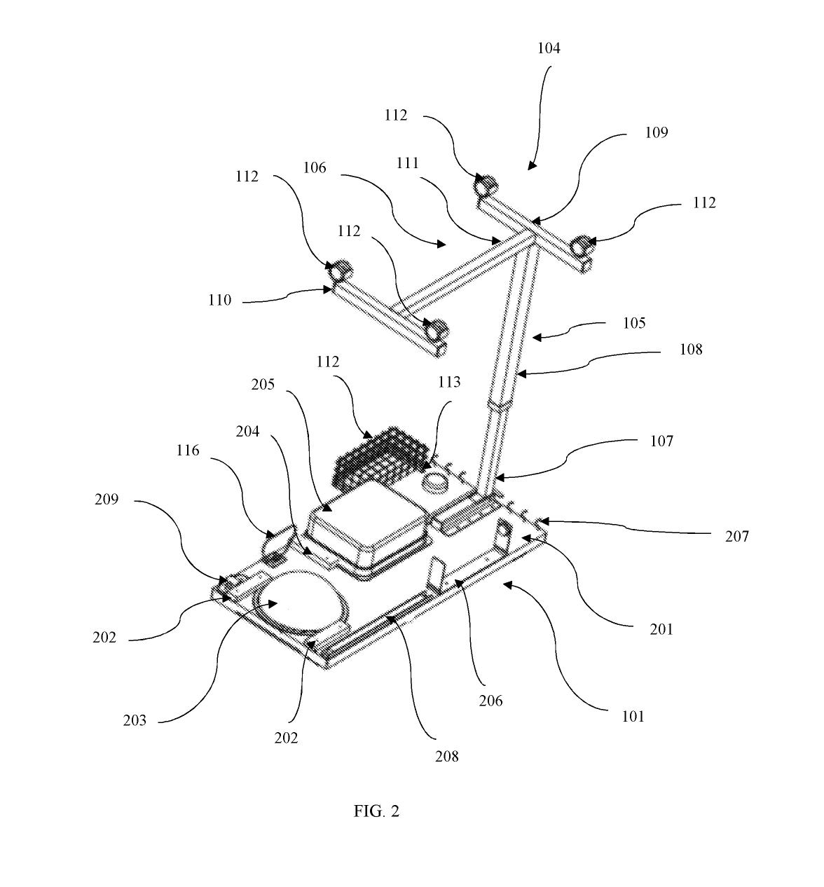

Referring now to FIGS. 1 and 2, which detail overhead and underside perspective views, respectively, of the preferred embodiment of the invention. The invention consists of a table 101, a support structure consisting of portable base frame 104. Depending on the user selected features, the table 101 may include a variety of built-in and/or attached items, including: a tray 114 for holding spices and/or condiments, utility hooks 207 to hold utensils, stowable and removable containers 203 and 205, cutting board 117, D-ring towel/garment holder 116, a cup/bottle/can holder 115, a magnet 208 for knives or metal utensils, paper towel dispenser 206, and/or a bottle opener 209.

Referring now to FIG. 1, which detail a perspective overhead view of the preferred embodiment of the invention. The table 101 is used as a caddy to hold cooking supplies, utensils, offering preparation space, and allowing the user an area to place buns, bread, plates or any other materials a person ordinarily uses during the cooking session. The table 101 is designed to allow the user to utilize equipment/utensils while cooking/barbecuing, with ease of use and an ergonomic efficiency. The preferred embodiment of the table is rectangular, with a longer, “length” axis and a shorter, “width” axis, a top surface, and an undersurface. However, other shapes, such as a circular, ovular, triangular, square, trapezoidal, etc. may be utilized for the table shape. In the preferred embodiment, the table is constructed of any one, or a mixture of woods, to include, but not be limited to: laminated pine and hard or soft rock maple, cherry, beech, ash, oak, purple heart, mahogany, cedar, teak, acacia white, or red oak; other materials, such as a metal, carbon fiber, plastic, laminated particle board, may also be used.

Under the preferred embodiment, the table is supported by a portable base frame 104. The portable base frame 104 consists of a height adjustable vertical leg 105 and a horizontal support structure 106. The vertical leg 105 consists of two pieces, an upper 107, L-shaped piece, with one end attaching to the underside of the table and a lower end 108, which fits inside a second piece, so that it may move up and down, depending on the user's table height preference. Height adjustment of the leg, may be accomplished through an incorporated hydraulic lever, a motorized device, or a manual system of an adjustable peg and hole system on the vertical leg. The bottom of the lower part of the vertical leg 108 connects to the horizontal support 106 structure. The horizontal support 106 is in an H-configuration, which runs underneath and parallel to the surface of the of the table 101 along the length axis, with a first 109 and a second 110 horizontal support bar; both horizontal support bars 109 and 110 run parallel to the width axis of the table surface; the horizontal support bars 109 and 110 are parallel to each other and connected by a connecting horizontal bar 111, which is perpendicular to the horizontal support bars 109 and 110. The bottom of the second part 108 of the vertical leg structure connects perpendicularly to the first horizontal support bar 109. The use of a single vertical leg 105 allows for implements to be placed along the underside of the table and for the user to not be blocked by additional legs. Alternative embodiments may use additional legs to support the table, such as in a traditional three- or four-legged table configuration.

Alternative embodiments may forego the portable base frame as the support structure and utilize a system of up to six legs attached to the under surface of the table. The leg(s) will have a top side, attached to the table and a bottom side, which will rest against a ground surface. The legs may be height adjustable, have wheels on the bottom side and or attached to the undersurface of the table with hinges, allowing the leg(s) to fold under the table for ease of storage and/or moving.

Under the preferred embodiment of the invention, a wheel 112 is placed at each end of each of the two horizontal support bars, allowing for the table to be positioned with ease. Each wheel 112 contains a built-in braking mechanism, so that the unit will stay in its desired location during use or storage. Alternative embodiments may use additional wheels or omit the wheels entirely.

Attached to a side or underside of the table 101, are metal brackets 113 used to hold a removable tray 114. This tray 114 is designed to hold spices used for seasoning meat or condiments such as ketchup, mustard, Worcestershire sauce, soy sauce, herbs, dry rubs, etc. The tray 114 is removable so that the user can fill it up with all the spices/condiments that they will need at a kitchen or other remote and/or remote location and set it on table-side mounted brackets keeping the tabletop free and open for other items or washing.

In the preferred embodiment, a notch or hole for a cup/bottle/can holder 115 is cut into or through the top surface. However, alternative embodiments may forego this feature.

Now referring to FIG. 2 which presents a perspective view of the undersurface of the table, including the preferred placement of implements on and around the underneath surface of the table.

Attached to the undersurface 201 of one side along the width axis of the table 101, opposite the vertical leg 105, are a first set of rails 202 intended to hold a container 203, such as mixing bowl, pan or tray, so that the container can either be stowed under the table or slide out for food to be slid/pushed directly from the cutting surface into the container. A second set of rails 204, for holding a second container 205, is attached to the undersurface of the along one of the length axis sides of the table. The rails 202 and 204 may be constructed of wood, metal or plastic. The containers 202 and 204 may be constructed of any materials, including: metal, plastic, glass, wood, paper, cardboard, etc.; and used for various functions such as marinating meat, transferring food from the kitchen, storing food under the table and keeping it warm until it's time to take it inside.

A paper towel dispenser 205 is fastened to the undersurface 201 of the table, this features built-in spring tension to hold paper towels securely to the table and allows the user to have paper towels at their disposal.

Utility hooks 207 are fastened along a width axis end of the undersurface 201 of the table, near the vertical leg, so the user can hang cooking utensils such as tongs, forks, grill brush, spoons, aprons etc. This allows the user to keep all the necessary tools exactly where they are being used.

A metal magnet 208 is attached to the undersurface of the table, so that the user can prepare food on the table and then quickly secure the knife to the magnet, keeping the tabletop free of dangerous, sharp objects and removing the chance of the knife being knocked off the table and causing an injury.

A D-ring wall mount towel/clothing holder 116, designed to allow the user to have a kitchen towel on hand for various uses, is mounted to the undersurface 201 of the table.

A bottle opener 209 is attached to the undersurface of the table or along one of the side surfaces. This is placed for user convenience, so that one has the ability to open beverages at the grill site and reduces trips to the kitchen or bring an extra utensil, which may be lost.

In some, embodiments, a recessed area may be cut into the top surface of the table to allow for the placement of a removable cutting board 117 to be recessed and flush with the surface; this is particularly useful, when the table is constructed of a softer wood, such as cedar, teak, acacia white, or red oak, where use of cutlery or other sharp objects may mar or damage the tabletop surface. The cutting board 117, may be made of wood, plastic, metal, and/or polycarbonate, allows the user to cut meat, fish, poultry etc. on the table. The placement of the cutting board near the edge of the table, allows the user to slice, dice and chop on the cutting board and then slide food directly into a container 203 for later use.

Under another embodiment of the invention, a hole is cut through the table, underneath the cutting board 117, with a container 203 situated under the hole. This allows the user to simply pick up the cutting board after use and slide the recently prepared food directly into the container 203 or use the container 203 as a waste receptacle.

In yet another embodiment, a removable waste receptacle is placed at a width end of the table, adjacent to the cutting board 117, allowing for convenient disposal of food waste, such as fruit/vegetable peelings and trimmed fat, and other garbage.

Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

I claim:

1. A food preparation table and carrier for outdoor grilling supplies used for cutting, preparing, handling, and containing various foods, comprised of a table and a support structure; wherein the table is rectangular in shape with a length axis and a width axis, a top surface, an undersurface and side surfaces along the length and width axes; wherein the food preparation table is constructed of any one or a mix of: laminated pine and hard or soft rock maple, cherry, beech, ash, oak, purple heart, mahogany, cedar, teak acacia white, or red oak, metal, carbon fiber, plastic or laminated particle board.

2. The food preparation table of claim 1, further comprising any combination of two removable basins, a towel holder, a bottle opener, a paper towel dispenser, a magnet, a tray, up to eight utility hooks, a tray; wherein the basins are each supported by sets of parallel runners located on the underside of the table; wherein the runners allow the basins to slide underneath the table, slide out, so that a basin is partially exposed, or allow a basin to be completely removed; wherein the up to eight hooks are underneath or along a side of the table; wherein the bottle opener, paper towel holder, towel holder are attached to the underside or one of the side surfaces of the table; wherein the tray is connected to the table by a set of brackets attached to the topside, underside or side surfaces of the table; wherein the tray is detachable from the brackets.

3. The food preparation table of claim 1, wherein a cup, can and/or bottle holder is placed into the top surface of the table or through the table.

4. The food preparation table of claim 1, wherein a removable container is mounted to one width axis end.

5. The food preparation table of claim 1, wherein the top surface of the food preparation table has a flat end and a routed end; wherein a removable cutting board fits inside the routed end, so that when the cutting board is in the routed end, the cutting board is flush with the table top surface.

6. The food preparation table of claim 5, wherein a hole is cut through the table, underneath the removable cutting board.

7. The food preparation table of claim 1, wherein the support structure, is comprised of a portable base frame
a. wherein the portable base frame consists of a height adjustable vertical leg and a horizontal support structure;
b. wherein the vertical leg consists of two pieces, an upper, L-shaped, first piece, with an upper end attaching to the underside of the table and a lower end, which fits inside a lower second piece; wherein the upper piece is able to move vertically, so as to adjust the height of the table;
c. wherein the height adjustment of the leg, may be accomplished through an incorporated hydraulic lever, a motorized device, or a manual system of an adjustable peg and hole system on the vertical leg;
d. wherein the bottom of the lower piece of the vertical leg connects to a horizontal support structure;
e. wherein the horizontal support is in an H-configuration, which runs underneath and parallel to a length axis of the table, with a first and a second horizontal support bar, both horizontal support bars run parallel, widthwise to the table surface;
f. wherein the horizontal support bars are parallel to each other and connected by a connecting horizontal bar, which runs perpendicular to the horizontal support bars;
g. wherein he bottom of the second part of the vertical leg structure connects perpendicularly to the first horizontal support bar.

8. The food preparation table of claim 7, wherein up to eight wheels are attached to the horizontal supports.

9. The food preparation table of claim 1, wherein the support structure is comprised of up to six legs arrayed around the under surface of the table; wherein the legs have a top side which is attached to the undersurface of the table and a bottom side which rests on the ground surface; wherein the legs are height adjustable and/or have wheels attached to the bottom side of the legs.

10. The food preparation table of claim 10, wherein the top side of the legs and under surface of the table are connected with hinges, so that the legs may be folded under the table.
